(19) United States
(12) Patent Application Publication
(10) Pub. No.: US 2009/0158969 A1
(43) Pub. Date: Jun. 25, 2009

(54) CONCRETE OPTIMIZED FOR HIGH WORKABILITY AND HIGH STRENGTH TO CEMENT RATIO

(75) Inventors: Per Just Andersen, Santa Barbara, CA (US); Simon K. Hodson, Santa Barbara, CA (US)

Correspondence Address: Patent Docket Department;Armstrong Teasdale LLP, One Metropolitan Square, Suite 2600, St. Louis, MO, 63102-2740, US

(73) Assignee: iCRETE, LLC, Beverly Hills, CA (US)

(21) Appl. No.: 12/247,823

(22) Filed: Oct. 8, 2008

Related U.S. Application Data
(60) Provisional application No. 61/016,345, filed on Dec. 21, 2007.

(51) Int. Cl. C04B 14/06

(52) U.S. Cl. 106/706; 106/705; 106/709

(57) ABSTRACT

A concrete composition having a 28-day design compressive strength of 4000 psi and a slump of about 5 inches is optimized to have high workability and a high strength to cement ratio. The concrete composition contains about 375 pounds per cubic yard hydraulic cement (e.g., Portland cement), about 113 pounds per cubic yard pozzolanic material (e.g., Type C fly ash), about 1735 pounds per cubic yard fine aggregate (e.g., FA-2 sand), about 1434 pounds per cubic yard coarse aggregate (e.g., CA-11 state rock, ¾ inch), and about 294 pounds per cubic yard water (e.g., potable water). Workability and strength to cement ratio were increased compared to one or more preexisting concrete compositions having the same 28-day design compressive strength and similar slump by optimizing the ratio of fine aggregate to coarse aggregate. The concrete composition is further characterized by high cohesiveness, resulting in relatively little or no segregation or bleeding.

### CROSS REFERENCE TO RELATED APPLICATION

This application is a non-provisional patent application claiming priority from U.S. Provisional Application 61/016,345 filed Dec. 21, 2007. The entire text of which is hereby incorporated by reference in its entirety.

### BACKGROUND OF THE DISCLOSURE

1. The Field of the Disclosure

The disclosure is in the field of concrete compositions, namely concrete compositions which include hydraulic cement, water and aggregates.

2. The Relevant Technology

Concrete is a ubiquitous building material that has been in use for millennia though it has experienced a modern revival since the discovery of Portland cement in the 1800s. It is used extensively for building roadways, bridges, buildings, walkways, and numerous other structures. Concrete manufacturers typically employ a variety of concrete mix designs having different strengths, slumps and other properties, which are optimized through trial and error testing and/or based on standard mix design tables.

The difficulty of optimizing concrete for a selected set of desired properties lies in its complexity, as the interrelationship between hydraulic cement, water, aggregate and admixtures can have multiple effects on strength, workability, permeability, durability, etc. Optimizing one property may adversely affect another. Moreover, the perceived low cost of concrete permits for routine overdesign and overcementing, which are tolerated in order to ensure a minimum guaranteed strength for a particular use.

Although it is often better to provide concrete that is too strong rather than too weak, this is not always the case. For one thing, overcementing can significantly increase cost as cement is one of the more expensive components of concrete. In addition, overcementing can result in poor concrete as it may result in long-term creep, shrinkage, and decreased durability. Using too much cement may also have adverse environmental consequences, such as increased use of fossil fuels in the manufacture of cement, which is a very energy intensive process. The manufacture of cement emits carbon dioxide (CO₂) into the environment as a result of the burning of fossil fuels to generate heat necessary to operate the kiln and the release of CO₂ from limestone used to generate calcium-silicates, -aluminates, -ferrates and other hydratable materials.

Stated more simply, any rational concrete manufacturer would like to make concrete that is both “better” (e.g., from the standpoint of workability, durability and consistency) and less expensive. Some may even care about the environment, particularly because giving the appearance of being “green” or environmentally friendly can be a beneficial marketing method.

Though the interrelated effects of varying the quantities of cement, water and aggregate are complex, part of the difficulty of optimizing concrete lies in its apparent simplicity. The common practice is to increase the amount of cement when it is desired to increase strength. This increases the quantity of cement paste and also reduces the water to cement ratio. However, this practice ignores the deleterious effect of overcementing and results in needless waste. It is not always appreciated how varying the ratio of fine to coarse aggregate can also affect strength, albeit indirectly through its effect on concrete rheology, workability and cohesiveness.

To better illustrate the difficulty of identifying the best “optimized” concrete mix design for a given set of raw materials that will yield concrete possessing the desired properties of strength, workability, etc., while also minimizing the use of cement, one should consider how many possible mix designs there are. First, assume that one can vary the amount of fine aggregate (e.g., sand) between 10-90% by volume of total aggregates, the amount of coarse aggregate (e.g., rock) between 10-90% by volume of total aggregates, the amount of cement between 5-30% by volume of the composition, and the amount of water between 5-30% by volume of the composition. Second, assuming that each of the foregoing components can be varied in 1% increments to yield meaningful differences in strength, workability and other properties, there would be approximately 50,000 possible concrete mix designs (i.e., 80×25×25=50,000). In reality, the number is much greater, as varying the amounts of components in even 0.1% increments can affect certain properties (i.e., 800×250×250=50 million). When one considers the many other components that can be added, such as pozzolans, multiple sizes and amounts of coarse aggregates, and various admixtures such as water reducers, air entraining agents, set accelerators, set retarders, plasticizers and the like, and that the number and amounts of such components can widely vary, the number of possible mix designs becomes incomprehensibly large (i.e., in the order of billions, if not trillions).

Given the extremely large number of possible concrete mix designs, coupled with the practical inability to test even a small fraction of such mix designs, the likelihood of identifying the most “optimized” mix design through trial and error testing and/or the use of standard tables is very small. Further complicating the picture, the quality of raw materials, manufacturing equipment, and manufacturing processes used to manufacture concrete can vary considerably between different geographic locations and manufacturers. Humidity and temperature can also affect results, as can personnel used to manufacture and place concrete. As a result, a single mix design can yield variable results between different manufacturers and even at the same manufacturing plant.

In summary, concrete manufacturers continue to produce concrete that is poorly optimized and overdesigned because of, among other things, (1) the practical difficulties of conducting trial and error testing on more than a relatively small number of mix designs, (2) the inability to understand and account for concrete variability when using a known mix design, and (3) a lack of understanding as to how fine tuning the ratio of fine to coarse aggregates, optionally in combination with the use of pozzolans and/or admixtures, can be used to obtain the best optimized concrete in terms of strength, workability and other properties while reducing the amount of cement required to achieve the desired properties compared to conventional concrete mix designs.

### BRIEF SUMMARY OF THE DISCLOSURE

The present disclosure is directed to an optimized concrete mix design for use in manufacturing concrete having a 28-day design compressive strength of 4000 psi (27.6 MPa) and a slump in a freshly mixed condition of 5 inches (12.7 cm). The concrete mix design yields concrete that is characterized by a high degree of workability and cohesiveness with minimal segregation and bleeding. The optimized concrete also contains a reduced quantity of hydraulic cement components (e.g., Type I/II Portland cements) compared to concrete having the same 28-day design compressive strength and the same or similar slump manufactured and sold previously by the same long preexisting manufacturer where the optimized concrete was tested.

The optimized concrete was designed, at least in part, by fine tuning the ratio of fine to coarse aggregate and designing a cement paste so that the aggregates and paste work together to yield better optimized concrete. The optimized ratio of fine to coarse aggregate in relation to the quantity and type of cement paste required to yield a composition having a design compressive strength of 4000 psi (27.6 MPa) and a slump of 5 inches (12.7 cm) provides both a high degree of workability (i.e., due to having a lower viscosity compared to less optimized concrete previously manufactured) and the desired strength with a greatly reduced strength to cement ratio.

The optimized concrete composition of the disclosure, in addition to having a higher ratio of strength to cement and lower viscosity, also possesses a high level of cohesiveness, which further enhances overall workability by inhibiting or minimizing segregation and bleeding. “Segregation” is the separation of the components of the concrete composition, particularly separation of the cement paste fraction from the aggregate fraction and/or the mortar fraction from the coarse aggregate fraction. “Bleeding” is the separation of water from the cement paste. Segregation can reduce the strength of the poured concrete and/or result in uneven strength and other properties. Reducing segregation may result in fewer void spaces and stone pockets, improved filling properties (e.g., around rebar or metal supports), and improved pumping of the concrete. Increasing the cohesiveness of concrete also contributes to improved workability because it minimizes the care and effort that must otherwise be taken to prevent segregation and/or bleeding during placement and finishing. Increased cohesiveness also provides a margin of safety that permits greater use of plasticizers without causing segregation and blocking.

The fact that the preexisting manufacturer had the best knowledge of its own raw materials inputs and manufacturing equipment and techniques, had many years to adjust the relative quantities of such raw materials inputs and conduct trial and error testing and/or consult standard tables, and had the benefit of existing design procedures, such as those provided by ASTM, but could not obtain the optimized concrete mix design, is evidence of the novelty of both the optimized concrete mix design itself as well as the design procedure utilized to obtain the optimized concrete mix design.

As will be discussed more fully below, the optimized concrete mix design disclosed herein utilizes the same or similar raw materials inputs as comparable mix designs previously employed having the same design strength and the same or similar slump. However, the optimized concrete mix design of the disclosure replaces prior art mix designs while significantly reducing the quantity of cement, and therefore the cost, compared to the previous mix design(s). Workability and other beneficial properties also equaled or exceeded those of previous mix design(s). These are surprising and unexpected results. They also demonstrate that the components were not simply selected in a manner so as to provide known or predictable results. Rather, the same or similar components employed using preexisting mix designs were used in different amounts according to the optimized concrete mix design and provide surprisingly and unexpectedly superior results (e.g., increased strength to cement ratio while equalizing or exceeding other desirable properties such as workability and cohesiveness). If the results of providing the same design strength and other desired properties at significantly lower cost were known or predicable to those of skill in the art, then certainly a manufacturer in the business of maximizing profits would have had a strong incentive to have previously altered the preexisting mix design(s) in order to obtain the optimized concrete mix design of the disclosure.

Apart from reducing cost, reducing the amount of cement would be expected to reduce or eliminate the deleterious effects of overcementing, such as creep, shrinkage, and/or decreased durability. It would also beneficially improve the environment by reducing the component of concrete (i.e., cement) that is responsible for the production and release into the atmosphere of high amounts of carbon dioxide (CO₂), which is believed to contribute to global warming as a greenhouse gas.

These and other advantages and features of the present disclosure will become more fully apparent from the following description and appended claims, or may be learned by the practice of the disclosure as set forth hereinafter.

### BRIEF DESCRIPTION OF THE DRAWINGS

To further clarify the above and other advantages and features of the present disclosure, a more particular description of the disclosure will be rendered by reference to specific embodiments thereof which are illustrated in the appended drawings. It is appreciated that these drawings depict only typical embodiments of the disclosure and are therefore not to be considered limiting of its scope. The disclosure will be described and explained with additional specificity and detail through the use of the accompanying drawings, in which:

FIG. 1 is a graph that schematically illustrates and compares the rheology of fresh concrete compared to a Newtonian fluid;

FIG. 2 is an exemplary ternary diagram of a three particle system consisting of cement, sand and rock illustrating a shift to the left representing an increase in the ratio of sand to rock compared to a preexisting concrete mix design;

FIGS. 3A and 3B are graphs that schematically illustrate the effect on the macro rheology of fresh concrete as a result of first increasing the sand to rock ratio and then adding a plasticizer to a concrete composition;

FIGS. 4A and 4B are graphs that schematically illustrate the effect on the micro rheology of fresh concrete as a result of first increasing the sand to rock ratio and then adding a plasticizer to a concrete composition; and

FIG. 5 is a flow diagram showing a general method for designing concrete having high workability.

### DETAILED DESCRIPTION OF THE PREFERRED EMBODIMENTS

### I. Introduction

The present disclosure is directed to an optimized concrete mix design for use in manufacturing concrete having a 28-day design compressive strength of 4000 psi (27.6 MPa) and a slump in a freshly mixed condition of 5 inches (12.7 cm). The concrete mix design yields concrete that is characterized by a high degree of workability and cohesiveness with minimal segregation and bleeding. The optimized concrete also contains a reduced quantity of hydraulic cement components (e.g., Type I/II Portland cements) compared to concrete having the same 28-day design compressive strength and the same or similar slump manufactured and sold previously by the same long preexisting manufacturer where the optimized concrete was tested.

As used herein, the term “concrete” refers to a composition that includes a cement paste fraction and an aggregate fraction and is an approximate Bingham fluid.

The terms “cement paste” and “paste fraction” refer to the fraction of concrete that includes, or is formed from a mixture that comprises, one or more types of hydraulic cement, water, and optionally one or more types of admixtures. Freshly mixed cement paste is an approximate Bingham fluid and typically includes cement, water and optional admixtures. Hardened cement paste is a solid which includes hydration reaction products of cement and water.

The terms “aggregate” and “aggregate fraction” refer to the fraction of concrete which is generally non-hydraulically reactive. The aggregate fraction is typically comprised of two or more differently-sized particles, often classified as fine aggregates and coarse aggregates.

The term “mortar fraction” refers to the paste fraction plus the fine aggregate fraction but excludes of the coarse aggregate fraction.

As used herein, the terms “fine aggregate” and “fine aggregates” refer to solid particulate materials that pass through a Number 4 sieve (ASTM C125 and ASTM C33).

As used herein, the terms “coarse aggregate” and “coarse aggregates” refer to solid particulate materials that are retained on a Number 4 sieve (ASTM C125 and ASTM C33). Examples of commonly used coarse aggregates include ⅜ inch rock and ¾ inch rock.

As used herein, “fresh concrete” refers to concrete that has been freshly mixed together and which has not reached initial set.

As used herein, the term “macro rheology” refers to the rheology of fresh concrete.

As used herein, the term “micro rheology” refers to the rheology of the mortar fraction of fresh concrete, exclusive of the coarse aggregate fraction.

As used herein, the term “segregation” refers to separation of the components of the concrete composition, particularly separation of the cement paste fraction from the aggregate fraction and/or the mortar fraction from the coarse aggregate fraction.

As used herein, the term “bleeding” refers to separation of water from the cement paste.

### II. Components Used to Make Optimized Concrete

The optimized concrete composition of the disclosure include at least one type of hydraulic cement, water, at least one type of fine aggregate, and at least one type of coarse aggregate. In addition to these components, the concrete compositions can include other admixtures to give the concrete desired properties.

A. Hydraulic Cement, Water, and Aggregate

Hydraulic cements are materials that can set and harden in the presence of water. The cement can be a Portland cement, modified Portland cement, or masonry cement. For purposes of this disclosure, Portland cement includes all cementitious compositions which have a high content of tricalcium silicate, including Portland cement, cements that are chemically similar or analogous to Portland cement, and cements that fall within ASTM specification C-150-00. Portland cement, as used in the trade, means a hydraulic cement produced by pulverizing clinker, comprising hydraulic calcium silicates, calcium aluminates, and calcium aluminoferrites, and usually containing one or more of the forms of calcium sulfate as an interground addition. Portland cements are classified in ASTM C 150 as Type I II, III, IV, and V. Other cementitious materials include ground granulated blast-furnace slag, hydraulic hydrated lime, white cement, slag cement, calcium aluminate cement, silicate cement, phosphate cement, high-alumina cement, magnesium oxychloride cement, oil well cements (e.g., Type VI, VII and VIII), and combinations of these and other similar materials.

The optimized concrete composition of the disclosure includes about 375 pounds of hydraulic cement (e.g., Type I Portland cement) per cubic yard of concrete. This amount, when used in combination with the specified amounts for the other components disclosed herein, yields optimal results but may be varied slightly in order to accommodate the inclusion of optional admixtures, fillers and/or different types of hydraulic cement. The amount of hydraulic cement within the optimized concrete composition of the disclosure will typically comprise 375±5% pounds per cubic yard of concrete, preferably 375±3% pounds per cubic yard of concrete, more preferably 375±2% pounds per cubic yard of concrete, and most preferably 375±1% pounds per cubic yard of concrete.

Pozzolanic materials such as slag, class F fly ash, class C fly ash and silica fume can also be considered to be hydraulically settable materials when used in combination with convention hydraulic cements, such as Portland cement. A pozzolan is a siliceous or aluminosiliceous material that possesses cementitious value and will, in the presence of water and in finely divided form, chemically react with calcium hydroxide produced during the hydration of portland cement to form hydratable species with cementitious properties. Diatomaceous earth, opaline, cherts, clays, shales, fly ash, silica fume, volcanic tuffs, pumices, and trasses are some of the known pozzolans. Certain ground granulated blast-furnace slags and high calcium fly ashes possess pozzolanic and cementitious properties. Fly ash is defined in ASTM C618.

The optimized concrete composition of the disclosure includes about 113 pounds of a pozzolanic material (e.g., Type C fly ash) per cubic yard of concrete. This amount, when used in combination with the specified amounts for the other components disclosed herein, yields optimal results but may be varied slightly in order to accommodate the inclusion of optional admixtures, fillers and/or different types of pozzolanic materials. The amount of pozzolanic material within the optimized concrete composition of the disclosure will typically comprise 113±5% pounds per cubic yard of concrete, preferably 113±3% pounds per cubic yard of concrete, more preferably 113±2% pounds per cubic yard of concrete, and most preferably 113±1% pounds per cubic yard of concrete.

Water is added to the concrete mixture in an amount to hydrate the cement and provide desired flow properties and rheology. The optimized concrete composition of the disclosure includes about 294 pounds of water (e.g., potable water) per cubic yard of concrete. This amount, when used in combination with the specified amounts for the other components disclosed herein, yields optimal results but may be varied slightly in order to accommodate the inclusion of optional admixtures and fillers. The amount of water within the optimized concrete composition of the disclosure will typically comprise 294±5% pounds per cubic yard of concrete, preferably 294±3% pounds per cubic yard of concrete, more preferably 294±2% pounds per cubic yard of concrete, and most preferably 294±1% pounds per cubic yard of concrete.

Aggregates are included in the concrete material to add bulk and to give the concrete strength. The aggregate includes both fine aggregate and coarse aggregate. Examples of suitable materials for coarse and/or fine aggregates include silica, quartz, crushed round marble, glass spheres, granite, limestone, bauxite, calcite, feldspar, alluvial sands, or any other durable aggregate, and mixtures thereof. In a preferred embodiment, the fine aggregate consists essentially of “sand” and the coarse aggregate consists essentially of “rock” (e.g., ⅜ inch and/or ¾ inch rock) as those terms are understood by those of skill in the art. Appropriate aggregate concentration ranges are provided elsewhere.

The optimized concrete composition of the disclosure includes about 1735 pounds of fine aggregate (e.g., FA-2 sand) per cubic yard of concrete. This amount, when used in combination with the specified amounts for the other components disclosed herein, yields optimal results but may be varied slightly in order to accommodate the inclusion of optional admixtures and fillers. The amount of fine aggregate within the optimized concrete composition of the disclosure will typically comprise 1735±5% pounds per cubic yard of concrete, preferably 1735±3% pounds per cubic yard of concrete, more preferably 1735±2% pounds per cubic yard of concrete, and most preferably 1735±1% pounds per cubic yard of concrete.

The optimized concrete composition of the disclosure includes about 1434 pounds of coarse aggregate (e.g., CA-11 state rock, ¾ inch) per cubic yard of concrete. This amount, when used in combination with the specified amounts for the other components disclosed herein, yields optimal results but may be varied slightly in order to accommodate the inclusion of optional admixtures and fillers. The amount of coarse aggregate within the optimized concrete composition of the disclosure will typically comprise 1434±5% pounds per cubic yard of concrete, preferably 1434±3% pounds per cubic yard of concrete, more preferably 1434±2% pounds per cubic yard of concrete, and most preferably 1434±1% pounds per cubic yard of concrete.

B. Admixtures and Fillers

A wide variety of admixtures and fillers can be added to the concrete compositions to give the fresh cementitious mixtures and/or cured concrete desired properties. Examples of admixtures that can be used in the cementitious compositions of the disclosure include, but are not limited to, air entraining agents, strength enhancing amines and other strengtheners, dispersants, water reducers, superplasticizers, water binding agents, rheology-modifying agents, viscosity modifiers, set accelerators, set retarders, corrosion inhibitors, pigments, wetting agents, water soluble polymers, water repellents, strengthening fibers, permeability reducers, pumping aids, fungicidal admixtures, germicidal admixtures, insecticidal admixtures, finely divided mineral admixtures, alkali reactivity reducer, and bonding admixtures.

Air-entraining agents are compounds that entrain microscopic air bubbles in cementitious compositions, which then harden into concrete having microscopic air voids. Entrained air dramatically improves the durability of concrete exposed to moisture during freeze thaw cycles and greatly improves a concrete's resistance to surface scaling caused by chemical deicers. Air-entraining agents can also reduce the surface tension of a fresh cementitious composition at low concentration. Air entrainment can also increase the workability of fresh concrete and reduce segregation and bleeding. Examples of suitable air-entraining agents include wood resin, sulfonated lignin, petroleum acids, proteinaceous material, fatty acids, resinous acids, alkylbenzene sulfonates, sulfonated hydrocarbons, vinsol resin, anionic surfactants, cationic surfactants, nonionic surfactants, natural rosin, synthetic rosin, inorganic air entrainers, synthetic detergents, the corresponding salts of these compounds, and mixtures of these compounds. Air entrainers are added in an amount to yield a desired level of air in a cementitious composition. Generally, the amount of air entraining agent in a cementitious composition ranges from about 0.2 to about 6 fluid ounces per hundred pounds of dry cement. Weight percentages of the primary active ingredient of the air-entraining agents (i.e., the compound that provides the air entrainment) are about 0.001% to about 0.1%, based on the weight of dry cementitious material. The particular amount used will depend on materials, mix proportion, temperature, and mixing action.

The strength enhancing amines are compounds that improve the compressive strength of concrete made from hydraulic cement mixes (e.g., Portland cement concretes). The strength enhancing agent includes one or more compounds from the group of poly(hydroxyalkylated)polyethyleneamines, poly(hydroxyalkylated)polyethylenepolyamines, poly(hydroxyalkylated)polyethyleneimines, poly(hydroxylalkylated)polyamines, hydrazines, 1,2-diaminopropane, polyglycoldiamine, poly(hydroxylalkyl)amines, and mixtures thereof. An exemplary strength enhancing agent is 2,2,2,2 tetra-hydroxydiethylenediamine.

Dispersants are used in concrete mixtures to increase flowability without adding water. Dispersants can be used to lower the water content in the plastic concrete to increase strength and/or obtain higher slump without adding additional water. A dispersant, if used, can be any suitable dispersant such as lignosulfonates, beta naphthalene sulfonates, sulfonated melamine formaldehyde condensates, polyaspartates, polycarboxylates with and without polyether units, naphthalene sulfonate formaldehyde condensate resins, or oligomeric dispersants. Depending on the type of dispersant, the dispersant may function as a plasticizer, high range water reducer, fluidizer, antiflocculating agent, and/or superplasticizer.

One class of dispersants includes mid-range water reducers. These dispersants are often used to improve the finishability of concrete flatwork. Mid-range water reducers should at least meet the requirements for Type A in ASTM C 494.

Another class of dispersants is high range water-reducers (HRWR). These dispersants are capable of reducing water content of a given mix by as much as 10% to 50%. HRWRs can be used to increase strength or to greatly increase the slump to produce “flowing” concrete without adding additional water. HRWRs that can be used in the present disclosure include those covered by ASTM Specification C 494 and types F and G, and Types 1 and 2 in ASTM C 1017. Examples of HRWRS are described in U.S. Pat. No. 6,858,074.

Viscosity modifying agents (VMA), also known as rheological modifiers or rheology modifying agents, can be added to the concrete mixture of the present disclosure. These additives are usually water-soluble polymers and function by increasing the apparent viscosity of the mix water. This enhanced viscosity facilitates uniform flow of the particles and reduces bleed, or free water formation, on the fresh paste surface.

Suitable viscosity modifiers that can be used in the present disclosure include, for example, cellulose ethers (e.g., methylcellulose, hydroxyethylcellulose, hydroxypropylmethylcellulose, carboxymethylcellulose, carboxymethylhydroxyethyl cellulose, methylhydroxyethylcellulose, hydroxymethylethylcellulose, ethylcellulose, hydroxyethylpropylcellulose, and the like); starches (e.g., amylopectin, amylose, seagel, starch acetates, starch hydroxy-ethyl ethers, ionic starches, long-chain alkylstarches, dextrins, amine starches, phosphates starches, and dialdehyde starches); proteins (e.g., zein, collagen and casein); synthetic polymers (e.g., polyvinylpyrrolidone, polyvinylmethyl ether, polyvinyl acrylic acids, polyvinyl acrylic acid salts, polyacrylimides, ethylene oxide polymers, polylactic acid polyacrylates, polyvinyl alcohol, polyethylene glycol, and the like); exopolysaccharides (also known as biopolymers, e.g., welan gum, xanthan, rhamsan, gellan, dextran, pullulan, curdlan, and the like); marine gums (e.g., algin, agar, seagel, carrageenan, and the like); plant exudates (e.g., locust bean, gum arabic, gum Karaya, tragacanth, Ghatti, and the like); seed gums (e.g., Guar, locust bean, okra, psyllium, mesquite, and the like); starch-based gums (e.g., ethers, esters, and related derivatized compounds). See, for example, Shandra, Satish and Ohama, Yoshihiko, “Polymers In Concrete”, published by CRC press, Boca Ration, Ann Harbor, London, Tokyo (1994).

Viscosity modifying agents are typically used with water reducers in highly flowable mixtures to hold the mixture together. Viscosity modifiers can disperse and/or suspend components of the concrete thereby assisting in holding the concrete mixture together.

Accelerators are admixtures that increase the rate of cement hydration. Examples of accelerators include, but are not limited to, nitrate salts of alkali metals, alkaline earth metals, or aluminum; nitrite salts of alkali metals, alkaline earth metals, or aluminum; thiocyanates of alkali metals, alkaline earth metals, or aluminum; thiosulphates of alkali metals, alkaline earth metals, or aluminum; hydroxides of alkali metals, alkaline earth metals, or aluminum; carboxylic acid salts of alkali metals, alkaline earth metals, or aluminum (such as calcium formate); and halide salts (such as bromides) of alkali metals or alkaline earth metals.

Set retarders, also known as delayed-setting or hydration control admixtures, are used to retard, delay, or slow the rate of cement hydration. They can be added to the concrete mix upon initial batching or sometime after the hydration process has begun. Set retarders are used to offset the accelerating effect of hot weather on the setting of concrete, or delay the initial set of concrete or grout when difficult conditions of placement occur, or problems of delivery to the job site, or to allow time for special finishing processes. Examples set retarders include lignosulfonates, hydroxylated carboxylic acids, borax, gluconic, tartaric and other organic acids and their corresponding salts, phosphonates, certain carbohydrates such as sugars and sugar-acids and mixtures of these.

Corrosion inhibitors in concrete serve to protect embedded reinforcing steel from corrosion due to its highly alkaline nature. The high alkaline nature of the concrete causes a passive and non-corroding protective oxide film to form on the steel. However, carbonation or the presence of chloride ions from deicers or seawater can destroy or penetrate the film and result in corrosion. Corrosion-inhibiting admixtures chemically arrest this corrosion reaction. The materials most commonly used to inhibit corrosion are calcium nitrite, sodium nitrite, sodium benzoate, certain phosphates or fluorosilicates, fluoroaluminates, amines, organic based water repelling agents, and related chemicals.

Dampproofing admixtures reduce the permeability of concrete that have low cement contents, high water-cement ratios, or a deficiency of fines in the aggregate. These admixtures retard moisture penetration into dry concrete and include certain soaps, stearates, and petroleum products.

Permeability reducers are used to reduce the rate at which water under pressure is transmitted through concrete. Silica fume, fly ash, ground slag, natural pozzolans, water reducers, and latex can be employed to decrease the permeability of the concrete.

Pumping aids are added to concrete mixes to improve pumpability. These admixtures thicken the fluid concrete, i.e., increase its viscosity, to reduce de-watering of the paste while it is under pressure from the pump. Among the materials used as pumping aids in concrete are organic and synthetic polymers, hydroxyethylcellulose (HEC) or HEC blended with dispersants, organic flocculents, organic emulsions of paraffin, coal tar, asphalt, acrylics, bentonite and pyrogenic silicas, natural pozzolans, fly ash and hydrated lime.

Bacteria and fungal growth on or in hardened concrete may be partially controlled through the use of fungicidal, germicidal, and insecticidal admixtures. The most effective materials for these purposes are polyhalogenated phenols, dialdrin emulsions, and copper compounds.

Fibers can be distributed throughout a fresh concrete mixture to strengthen it. Upon hardening, this concrete is referred to as fiber-reinforced concrete. Fibers can be made of zirconium materials, carbon, steel, fiberglass, or synthetic polymeric materials, e.g., polyvinyl alcohol (PVA), polypropylene (PP), nylon, polyethylene (PE), polyester, rayon, high-strength aramid (e.g., p- or m-aramid), or mixtures thereof.

Shrinkage reducing agents include but are not limited to alkali metal sulfate, alkaline earth metal sulfates, alkaline earth oxides, preferably sodium sulfate and calcium oxide.

Finely divided mineral admixtures are materials in powder or pulverized form added to concrete before or during the mixing process to improve or change some of the plastic or hardened properties of Portland cement concrete. The finely divided mineral admixtures can be classified according to their chemical or physical properties as: cementitious materials; pozzolans; pozzolanic and cementitious materials; and nominally inert materials. Nominally inert materials include finely divided raw quartz, dolomites, limestones, marble, granite, and others.

Alkali-reactivity reducers can reduce the alkali-aggregate reaction and limit the disruptive expansion forces in hardened concrete. Pozzolans (fly ash and silica fume), blast-furnace slag, salts of lithium, and barium are especially effective.

Bonding admixtures are usually added to hydraulic cement mixtures to increase the bond strength between old and new concrete and include organic materials such as rubber, polyvinyl chloride, polyvinyl acetate, acrylics, styrene-butadiene copolymers, and powdered polymers.

Natural and synthetic admixtures are used to color concrete for aesthetic and safety reasons. These coloring admixtures are usually composed of pigments and include carbon black, iron oxide, phthalocyanine, umber, chromium oxide, titanium oxide and cobalt blue.

### III. Improved Workability of Optimized Concrete

The optimized concrete composition of the disclosure is a mixture of cement, water, aggregates, and optionally other admixtures that are selected and combined to optimize workability. The workability of the fresh cementitious composition is optimized by selecting a fine-to-coarse aggregate ratio that greatly reduces or minimizes viscosity. The ability to improve the workability of a cementitious material by selecting a desired ratio of fine to coarse aggregates is derived from the nature of fresh concrete, which in some respects approximates the behavior of a Bingham fluid. Information relating to concrete rheology in general, and Binghamian behavior in particular, is found in Andersen, P., “Control and Monitoring of Concrete Production: A Study of Particle Packing and Rheology,” Danish Academy of Technical Sciences, Doctoral Thesis (1990) (“Andersen Thesis”), which is incorporated by reference.

A. Concrete Rheology

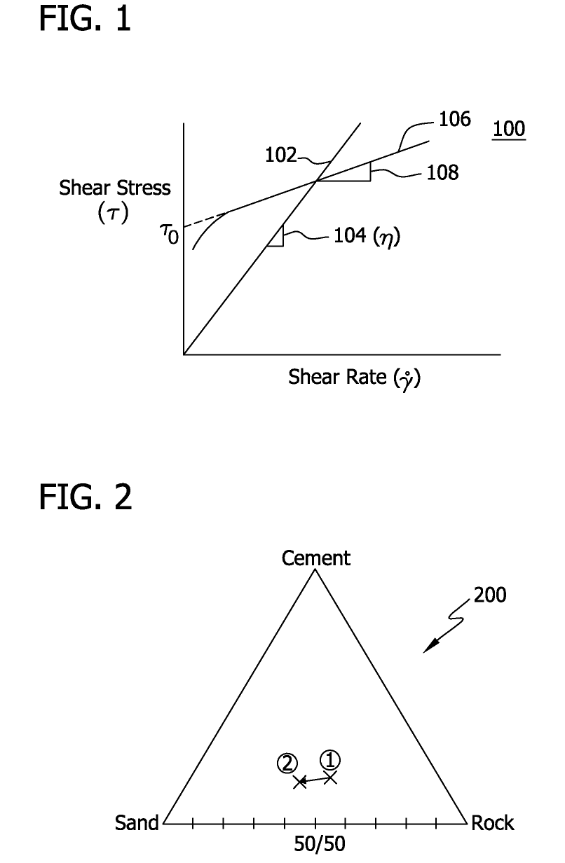

FIG. 1 shows a schematic diagram 100 illustrating the rheology of concrete, which is an approximate Bingham fluid, as it compares to a Newtonian fluid such as water. Water is a classic Newtonian fluid in which the relationship between shear stress (τ) and shear rate (\dot{γ}) is represented by a linear curve 102 (i.e., a straight line of constant slope 204) that passes through the origin. The slope 104 of the curve 102 represents the viscosity (η), and the y-intercept of the curve 102 represents the yield stress (τ₀), or shear stress (τ) when the shear rate (\dot{γ}) is 0. The yield stress (τ₀) of a Newtonian fluid is 0 when the shear rate (\dot{γ}) is 0. That means a Newtonian fluid is able to flow under the force of gravity without applying additional force. Nevertheless, the linear curve 102 can be adjusted so as to have different slopes corresponding to Newtonian fluids having higher or lower viscosities.

In contrast, the rheological behavior of concrete can be approximated according to the following equation:

τ=τₒ+ηₚₗ^{-\dot{γ}} (1)

where τ is the amount of force or placement energy required to move fresh concrete into a desired configuration,

τₒ is the yield stress (i.e., the amount of energy required to initially cause fresh concrete to initially move from a stationary position),

ηₚₗ is the plastic viscosity of fresh concrete (i.e., the change in shear stress divided by the change in shear rate), and

\dot{γ} is the shear rate (i.e., the rate at which the concrete material is moved during placement).

The foregoing relationship can be plotted graphically for any fresh concrete composition having a positive slump and an approximate Bingham fluid behavior. Bingham fluid curve 106 shown in FIG. 1 has a changing slope at lower shear rates, a generally constant slope 108 at higher shear rates, and a positive y-intercept τₒ, which is representative of the yield stress and which can be extrapolated by extending the straight portion of curve 106 using slope 108 to the y-axis. At low shear rates, the slope of curve 106 decreases with increasing shear rate, which means the apparent (or plastic) viscosity (ηₚₗ) of a Bingham fluid such as concrete initially decreases with increasing shear (\dot{γ}). That is because approximate Bingham fluids such as concrete typically experience shear thinning. A Bingham has a positive yield stress (τₒ), whose value can be extrapolated from the slope 108 of the straight line portion of the Bingham fluid curve 106. In the case of concrete, the yield stress (τₒ) is approximately inversely proportional to slump.

B. Relationship Between Concrete Rheology and Workability

The placement energy required to configure and finish fresh concrete can be represented by τ. Both the yield stress (τₒ) and plastic viscosity (ηₚₗ) are components of τ, as indicated by equation (1) above. One measure of “workability” of fresh concrete is the inverse of placement energy, as indicated by the following equation:

$$Workability = \frac{1}{τ} = \frac{1}{{τ}_{0} + {η}_{pl} \cdot \dot{γ}} \qquad ( 2 )$$

That is, the workability of fresh concrete increases as the amount of placement energy required to configure concrete decreases. Conversely, the workability decreases as the as the amount of placement energy required to configure concrete increases.

Slump is commonly used as the measure of concrete workability, e.g., as measured using ASTM-C143, and increasing the slump is understood to require less energy to position and finish the concrete. The problem with this assumption is that concrete is not a fluid, but a multi-phase mixture of liquid, solid and air that cannot be made to behave as a true fluid without eliminating the aggregate fraction. Aggregates do not themselves “flow” but rather move together with the paste fraction of fresh concrete. Increasing the fluidity of the cement paste does not increase the fluidity of the aggregate fraction. If the cement paste is made excessively fluid, the cement paste fraction will separate and move independently of the aggregate fraction, which causes “segregation”. Moreover, cement paste is also not a fluid because it contains solid cement grains suspended in a liquid phase consisting of water and liquid and/or dissolved admixtures. Adding too much fluid to the cement paste will cause the liquid phase to separate and move independently of the cement grains, which causes “bleeding”.

To prevent segregation, concrete must possess sufficient cohesion to maintain the required distribution of solid aggregates, cement paste, and air within the concrete mixture. Similarly, to prevent bleeding, the cement paste fraction must possess sufficient paste cohesion to maintain a homogeneous distribution of cement grains and liquid fraction. However, increasing the cohesion of both concrete and paste significantly affect both the yield stress and viscosity of the mixture, both of which have been found to affects workability. There is therefore a natural limit to the amount of fluidity that can be imparted to fresh concrete, using conventional concrete design and manufacturing methods, beyond which segregation and bleeding result in the absence of adding substantial quantities of expensive rheology-modifying admixtures.

Where gravity alone is relied on to place concrete (i.e., where the shear rate representative of added energy can be treated as if it approaches zero), the yield stress becomes the major component of workability according to the following equation:

$$\begin{matrix}lim \\ \dot{γ} = 0\end{matrix} ⇒ \frac{1}{τ} ≅ \frac{1}{{τ}_{0}} \qquad ( 3 )$$

As discussed above, and shown in FIG. 9, concrete slump is inversely related to the yield stress. Thus, if gravity alone were required to place concrete, the slump would be an accurate measure of workability (i.e., increased slump would correlate with increased workability). However, gravity alone is rarely the only force required to place or configure concrete. Instead, concrete must be typically be pumped and/or channeled through a trough, moved into place, consolidated and surface finished.

Where a high amount of placement energy in addition to the force of gravity is required to position concrete (i.e., where the shear rate representative of added energy can be treated as if it approaches infinity), the viscosity of concrete becomes the major component of workability according to the following equation:

$$\begin{matrix}lim \\ \dot{γ} = ∞\end{matrix} ⇒ \frac{1}{τ} ≅ \frac{1}{{N}_{pl} \cdot \dot{γ}} \qquad ( 4 )$$

In some cases, both the yield stress and viscosity can significantly contribute to or affect workability according to workability equation (2) shown above.

The vast majority of concrete, whether lower strength concrete used to make sidewalks, driveways and foundations for single dwelling house, or high strength concretes used to manufacture roads, bridges and structural portions of large buildings, has a positive slump in a range of about 1-12 inches (about 2.5-30 cm) as measured using a standard slump cone. Such compositions have substantial Binghamian fluid properties that render slump a poor measure of overall workability. That is because substantial energy above and beyond the force of gravity (i.e., “placement energy”) is generally required to position the concrete into a desired configuration and, in some cases, finish the surface. Slump only measures the flow of concrete under the force of gravity but does not measure the further energy required to position concrete beyond what occurs through gravity alone.

Decreasing the viscosity of fresh concrete generally decreases the overall amount of placement energy or work required to position the concrete into a desired configuration. Conversely, increasing the viscosity generally increases the overall amount of placement energy required to position the concrete into the desired configuration. Because workability is inversely proportional to the amount of placement energy required to position concrete, decreasing the viscosity increases workability because it decreases the amount of placement energy required to position concrete. Because slump only measures the tendency of concrete to flow under the force of gravity, but not the tendency of concrete to flow in response to placement energy input in addition to gravity, in some cases. slump is an inaccurate measure of placement workability for concrete that is not 100% self-leveling.

C. Effect of Fine to Coarse Aggregate Ratio on Rheology

FIG. 2 illustrates a simplified ternary diagram that can be used to graphically depict the relative volumes of cement, rock and sand in a concrete mixture for any point within the triangle. Points within the triangle describe concrete mixtures that include cement, sand and rock. The top point of the triangle near the word “cement” represents a hypothetical composition that includes 100% cement and no sand or rock aggregate. The bottom left point of the triangle near the word “sand” represents a hypothetical composition that includes 100% sand and no cement or rock. The bottom right point of the triangle near the word “rock” represents a hypothetical composition that includes 100% rock and no cement or sand. Any point along the bottom line of the triangle between “sand” and “rock” represents a hypothetical composition that includes various volumetric ratios of sand to rock but no cement. Any line above and parallel to the bottom of the triangle represents compositions having different volumetric ratios of sand and rock but a constant volume of cement.

Composition 1, labeled by an “X”, schematically represents a less optimized concrete composition designed according to conventional techniques and utilized by a preexisting manufacturer. The ratio of sand to rock is approximately 45:55. That is, of the aggregate fraction, 45% of the aggregate is sand and 55% is rock.

Composition 2, also labeled by an “X”, schematically represents a better optimized concrete composition. The shift to the left from Composition 1 to Composition 2 indicates an increase in the sand to rock ratio. The ratio of sand to rock in Composition 2 is approximately 55:45. That is, of the aggregate fraction, 55% of the aggregate is sand and 45% is rock. The downward slope of the line between Composition 1 and Composition 2 indicates that there is a reduction in the cement content. As long as the strength remains the same, this shift results in an increased strength to cement ratio.

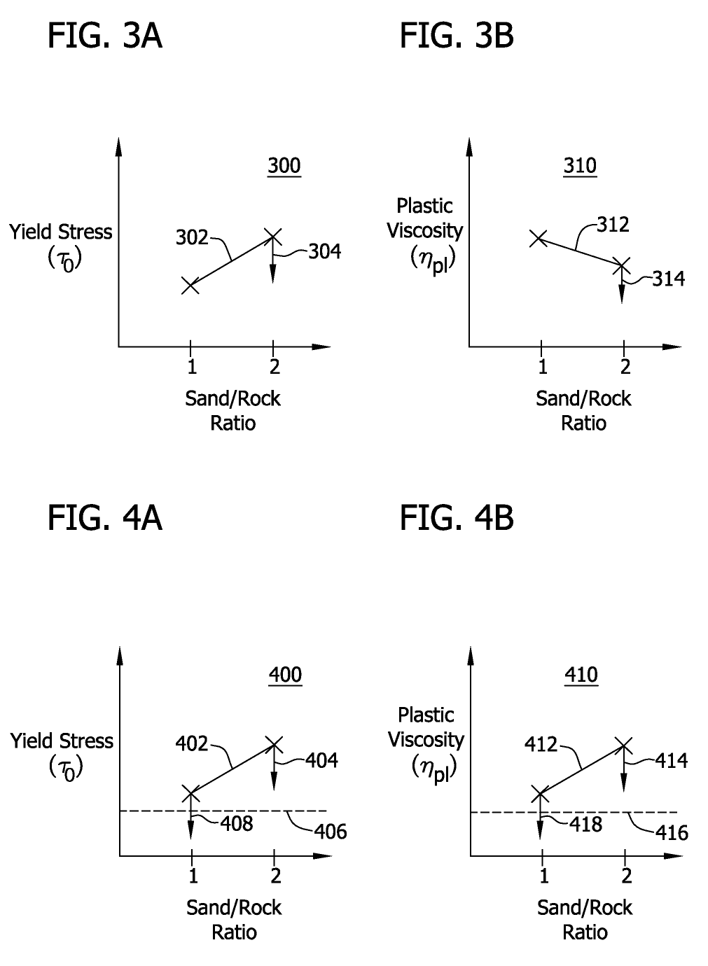

Composition 2 has a better optimized ratio of sand to rock, and was found to have better workability, compared to Composition 1. To help explain this phenomenon, reference is now made to FIGS. 3A and 3B, which illustrate the effect of optimizing the ratio of sand to rock in Composition 2 on macro rheology (i.e., of the fresh concrete composition), and FIGS. 4A and 4B, which illustrate the effect of optimizing the sand to rock ratio on micro rheology (i.e., of the mortar fraction exclusive of the rock fraction).

FIG. 3A is a graph 300 which schematically depicts the effect on the yield stress of the fresh concrete composition by adjusting the sand to rock ratio from point 1 to point 2 in the ternary diagram of FIG. 2. Line 302 has a positive slope, which indicates that the yield stress increased by increasing the sand to rock ratio from 45:55 to 55:45. Increased yield stress correlates to decreased slump.

FIG. 3B is a graph 310 which schematically depicts the effect on the viscosity of a fresh concrete composition by adjusting the sand to rock ratio from point 1 to point 2 in the ternary diagram of FIG. 2. Line 312 has a negative slope, which indicates that the plastic viscosity of the composition decreased by increasing the sand to rock ratio from 45:55 to 55:45. Because decreased viscosity results in increased workability, simply moving from point 1 to point 2 in the ternary diagram of FIG. 2 would have the effect of improving workability notwithstanding the decrease in slump.

Nevertheless, there are situations which require a certain minimum slump for placement. In order to increase the slump (e.g., back to where it was in composition 1), a plasticizer (e.g., water reducer or superplasticizer) can be added, which reduces the yield stress and increases the slump. The effect of adding a plasticizer on yield stress is schematically illustrated in FIG. 3A as line 304 of graph 300. Adding the plasticizer can also beneficially reduce the viscosity, as schematically illustrated by line 314 of graph 310 in FIG. 3B. Thus, the combined effect of better optimizing the sand to rock ratio and adding a plasticizer can be to maintain a desired slump while substantially decreasing the viscosity. The net effect is a substantial decrease in the placement energy required to configure the concrete, which equates to a substantial increase in workability.

Instead or in addition to increased workability, moving from point 1 to point 2 may permit a reduction in the amount of water that would otherwise be required to provide a desired workability. Reducing the amount of water lowers the water to cement ratio, which increases strength. In order to maintain the same level of desired strength, the quantity of cement can also be reduced, thereby increasing the ratio of strength to cement in the optimized concrete composition compared to the less optimized concrete composition.

This increase in workability and/or strength to cement ratio can also be achieved without a corresponding increase in segregation and/or bleeding, which would occur if one were to attempt to lower the viscosity of composition 1 using a plasticizer. This is best understood by comparing the effects of the sand to rock ratio as between compositions 1 and 2 on the micro rheology of fresh concrete, as illustrated in FIGS. 4A and 4B. FIG. 4A is a graph 400 which schematically depicts the effect on the yield stress of the mortar fraction by adjusting the sand to rock ratio from point 1 to point 2 in the ternary diagram of FIG. 2. Line 402 has a positive slope, which indicates that the yield stress of the mortar fraction increased by adjusting the sand to rock ratio from 45:55 to 55:45.

FIG. 4B is a graph 410 which schematically depicts the effect on the viscosity of the mortar fraction by increasing the sand to rock ratio from point 1 to point 2 in the ternary diagram of FIG. 2. Line 412 also has a positive slope, which indicates that the plastic viscosity of the mortar fraction increased by adjusting the sand to rock ratio from 45:55 to 55:45. The increase in viscosity and yield stress of the mortar fraction by moving from point 1 to point 2 in the ternary diagram of FIG. 2 improves workability of the fresh concrete because it translates into increased cohesiveness, which decreases segregation and bleeding. The increase in cohesiveness can be beneficial in and of itself, as it can be achieved while also decreasing the macro viscosity of the fresh concrete composition.

The increased cohesiveness also provides a margin of safety that permits greater use of plasticizers to improve concrete workability. Referring again to graph 400 of FIG. 4A, dotted line 406 schematically depicts a minimum yield stress threshold of the mortar fraction below which an unacceptable level of segregation and/or bleeding of the fresh concrete composition occurs. Simply adding a plasticizer to Composition 1, as schematically illustrated by line 408 of graph 400, can cause the yield stress of the mortar fraction to dip below the minimum yield stress threshold 406 required to prevent unacceptable segregation and/or bleeding. Dotted line 416 of graph 410 in FIG. 4B depicts a similar minimum viscosity threshold required to prevent unacceptable segregation and/or bleeding. Simply adding a plasticizer to composition 1, as schematically illustrated by line 418 of graph 410, can cause the viscosity of the mortar fraction to dip below the minimum viscosity threshold required to prevent unacceptable segregation and/or bleeding.

In contrast, the increased yield stress and viscosity of the mortar fraction in Composition 2, as depicted in FIGS. 4A and 4B, provides a margin of safety that permits greater use of plasticizers to improve concrete workability of the fresh concrete composition. This margin of safety is schematically illustrated by line 404 of graph 400 in FIG. 4A and line 414 of graph 410 of FIG. 4B, which show how the yield stress and viscosity of the mortar fraction of Composition 2 can be decreased using a plasticizer while remaining above the minimum yield stress and viscosity thresholds 506 and 516 required to prevent unacceptable segregation and/or bleeding.

In summary, FIGS. 2-4 schematically illustrate the beneficial effect of better optimizing the sand to rock ratio on workability, and also the ability to employ greater use of plasticizers to further improve workability beyond what is possible using conventional concrete compositions and design techniques. While increasing the ratio of sand to rock is generally beneficial from the standpoint of workability, it has been found that the optimal amount of fine aggregate can vary depending on concrete strength, which is a function of the cement content. That is because both cement and the fine aggregate affect the macro and micro rheology of concrete. In general, increasing the cement content generally reduces the amount of fine aggregate required to optimize workability of a fresh concrete composition. Conversely, decreasing the cement content increases the amount of fine aggregate required to optimize workability of a fresh concrete composition. The optimal ratio of fine to coarse aggregate may therefore roughly depend on concrete strength.

### IV. Method for Optimizing Concrete

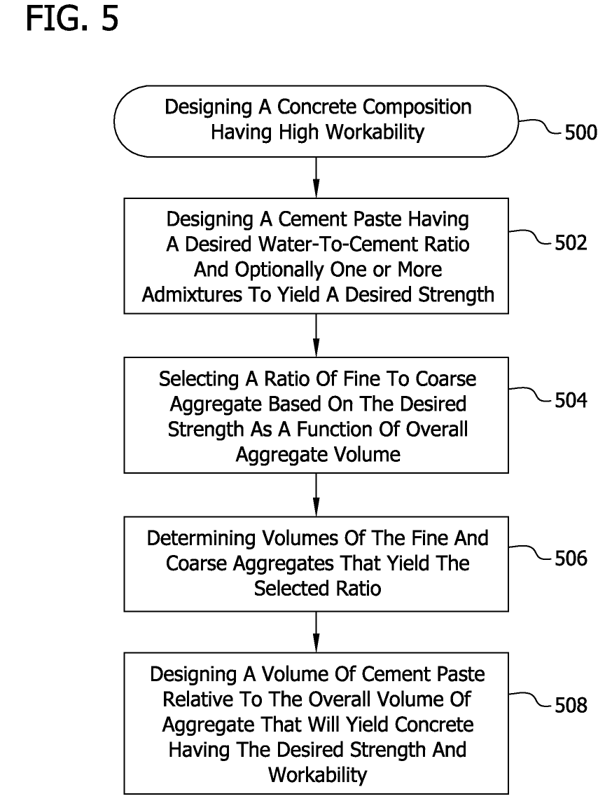

FIG. 5 is a flow diagram 500 describing the steps that can be used to design an optimized concrete composition having improved workability and a higher strength to cement ratio. Step 502 includes designing a cement paste having a desired water-to-cement ratio to yield a desired strength. The cement paste can optionally include any number or any amount of admixtures that will contribute to yielding paste having the desired strength. Optionally, the cement paste can also include admixtures to adjust the rheology or other properties of the cement paste.

In step 504, a ratio of fine aggregates to coarse aggregates is selected in part based on the desired strength. The ratio of fine aggregates to coarse aggregates is selected so as to optimize (e.g., minimize) the viscosity of the concrete composition when a particular type and amount of cement paste is used to achieve the desired strength.

Step 506 includes determining the volume of fine aggregate and also the volume of coarse aggregate that will yield the ratio of fine to coarse aggregates selected in step 504. Similarly, step 508 includes determining the volume of cement paste relative to the overall volume of fine and coarse aggregates that will yield a concrete composition having the desired strength and workability.

In one embodiment, the desired ratio of fine to coarse aggregates can be determined by constructing a narrow range of the fine aggregate content that minimizes the viscosity of the concrete composition. In one embodiment, a fine to coarse aggregate ratio is selected to give a viscosity that is within about 5% of the viscosity minimum, more preferably within about 4% of the viscosity minimum, and most preferably within about 3% of the viscosity minimum.

With reference again to FIG. 5, in step 506, the volumes of the fine and coarse aggregates that yield the selected ratio is determined. This determination is typically made by calculating the total amount of concrete that is to be manufactured and calculating the volume of each of the coarse and fine aggregates needed for that volume. The volume of the aggregates to be used in the mix design can also be converted to a weight value (e.g., pounds or kilograms) to facilitate measuring and dispensing the aggregates during the actual mixing process. In step 508, the quantity of cement paste relative to the quantity of total aggregate is determined such that the concrete manufactured from these two components will yield concrete having the desired strength and workability.

A design optimization method useful for optimizing concrete compositions so as to have certain predetermined or desired properties is set forth in U.S. Application Publication No. 2006/0287773, naming Per Just Andersen and Simon K. Hodson as inventors and entitled “Methods and Systems for Redesigning Pre-Existing Concrete Mix Designs and Manufacturing Plants and Design-Optimizing and Manufacturing Concrete,” the disclosure of which is incorporated herein.

### V. Method for Manufacturing Concrete

The cementitious compositions can be manufactured using any type of mixing equipment so long as the mixing equipment is capable of mixing together a cementitious composition with the desired ratios of fine aggregates to coarse aggregates to achieve the improvement in workability. Those skilled in the art are familiar equipment that is suitable for manufacturing cementitious composition having both fine and coarse aggregates.

In one embodiment, the cementitious composition of the disclosure is manufactured in a batch plant. Batch plants can be advantageously used to prepare cementitious compositions according to the present disclosure. Batching plants typically have large scale mixers and scales for dispensing the components of the concrete in desired amounts. The use of equipment that can accurately measure and/or dispense the components of the concrete composition advantageously allows the workability to be controlled to a greater extent than using a look and feel approach. Thus, obtaining the desired ratio of aggregates within the narrow ranges that give the most improvement in workability can be more easily achieved in a batching plant. In one embodiment, the batching plant is computer controlled to precisely measure and dispense the components to be mixed. For purposes of this disclosure, batching plants are concrete manufacturing plants with the capacity to mix at least about 1 cubic yard (or approximately 1 cubic meter).

### VI. COMPARATIVE EXAMPLES

The following mix designs are given by way of example to illustrate the optimized concrete composition of the disclosure. Examples provided in the past tense were actually manufactured and those in the present tense are either hypothetical in nature or extrapolations from a mix design that was manufactured and tested.

### Example 1

An optimized concrete composition of the disclosure having a 28-day design compressive strength of 4000 psi and a slump of 5 inches was manufactured according to the following mix design:

| | | |
|---|---|---|
| Hydraulic Cement (Type I) | 375 | lbs/yd³ |
| Pozzolan (Type C fly ash) | 113 | lbs/yd³ |
| Fine Aggregate (FA-2 sand) | 1735 | lbs/yd³ |
| Coarse Aggregate (CA-11 state rock, | 1434 | lbs/yd³ |
| ¾ inch) | | |
| Water (potable) | 294 | lbs/yd³ |
| Air | 2 | vol. % |

The optimized concrete composition is characterized as having relatively high workability, little or no segregation and bleeding, and a substantially higher strength to cement ratio compared to the concrete compositions of Comparative Examples 1a-1c, set forth below. The materials cost of the optimized concrete composition was determined to be $38.39, based on materials prices existing on Apr. 7, 2006.

### Comparative Examples 1a-1c

Conventional concrete compositions made according to the mix designs of comparative Examples 1a-1c, set forth in Table 1, were manufactured and sold by a preexisting concrete manufacturer for a number of years and represented the state of the art as understood by the manufacturer. One may objectively assume that the manufacturer of concrete compositions made according to Comparative Examples 1a-1c possesses ordinary skill in the concrete art.

TABLE 1

| | Comparative Example | | | |
|---|---|---|---|---|
| | 3a | 3b | 3c | Cost (US$) |
| 28-Day design comp. | 4000 | 4000 | 4000 | — |
| strength (psi) | | | | |
| Slump (inch) | 4 | 4 | 4 | — |
| Type 1 cement (lbs/yd³) | 470 | 564 | 517 | $101.08/Ton |
| Type C fly ash (lbs/yd³) | 100 | 0 | 0 | $51.00/Ton |
| FA-2 sand (lbs/yd³) | 1530 | 1440 | 1530 | $9.10/Ton |
| CA-11 state rock (lbs/yd³) | 1746 | 1750 | 1750 | $11.65/Ton |
| Potable water (lbs/yd³) | 280 | 285 | 280 | negligible |
| Daracem 65 (water red.) | 0 | 0 | 18.1 | $5.65/Gal |
| (fl. oz./cwt) | | | | |
| % Air | 1.5 | 1.5 | 1.5 | — |
| Cost ($/yd³) | $43.73 | $45.53 | $47.71 | — |
| Sales Distribution (%) | 6.81 | 44.35 | 48.84 | — |
| Within Group | | | | |

| | | |
|---|---|---|
| Weighted Average Cost | $46.47 | — |
| ($/yd³) | | |

Based on the foregoing, the optimized concrete composition of Example 1 utilized substantially less hydraulic cement compared to the conventional concrete compositions of Comparative Examples 1a-1c, while maintaining the same design compressive strength and equaling or exceeding workability and cohesivness by empirical (e.g., visual) inspection. The optimized concrete composition of Example 1 has a significantly higher strength to cement ratio than each of Comparative Examples 1a-1c. This is a surprising and unexpected result, particularly since Example 1 uses the exact same components as Comparative Examples 1a and 1b and substantially the same components as Comparative Example 1c.

The optimized concrete composition of Example 1 is sufficiently versatile as to be able to replace the three concrete compositions of Comparative Examples 1a-1c, thus simplifying the manufacturing and distribution process. In addition, the optimized concrete composition of Example 1 represented an average cost savings of $8.08 (more than 17%) compared to the preexisting concrete compositions of Comparative Examples 1a-1c. This is further evidence of the unexpected and unpredictable nature of the optimized concrete composition of Example 1. The preexisting manufacture, though it had years or decades to identify what it objectively understood to be well designed and optimized concrete mix designs, was unable to obtain the better optimized concrete composition of Example 1. The fact that the manufacturer continued to utilize the less optimized mix designs of Comparative Examples 1a-1c rather than the better optimized mix design of Example 1 (which was able to reduce the materials cost by more than 17%) objectively demonstrates that either the manufacture did not care about increasing its profit margin or else it lacked the ability to better optimize its own preexisting concrete mix designs.

### Example 2

A concrete composition is manufactured using a modified mix design derived from Example 1, except that the quantities of the various components are increased and/or decreased by an amount of up to 5%. The resulting concrete composition would be expected to be better optimized than each of Comparative Examples 1a-1c but not as well optimized as Example 1.

### Example 3

A concrete composition is manufactured using a modified mix design derived from Example 1, except that the quantities of the various components are increased and/or decreased by an amount of up to 3%. The resulting concrete composition would be expected to be better optimized than each of Comparative Examples 1a-1c and also Example 2 but not as well optimized as Example 1.

### Example 4

A concrete composition is manufactured using a modified mix design derived from Example 1, except that the quantities of the various components are increased and/or decreased by an amount of up to 2%. The resulting concrete composition would be expected to be better optimized than each of Comparative Examples 1a-1c and also Examples 2 and 3 but not as well optimized as Example 1.

### Example 5

A concrete composition is manufactured using a modified mix design derived from Example 1, except that the quantities of the various components are increased and/or decreased by an amount of up to 1%. The resulting concrete composition would be expected to be better optimized than each of Comparative Examples 1a-1c and also Examples 2-4 but not as well optimized as Example 1.

### Example 6

Any of Examples 2-5 is modified by adding one or more admixtures and/or fillers in order to improve one or more desired properties.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

1-15. (canceled)

16. A concrete composition having high workability and a high strength to cement ratio, comprising:
hydraulic cement in an amount of 366±5% pounds per cubic yard;
a pozzolanic material in an amount of 110±5% pounds per cubic yard;
a fine aggregate in an amount of 1654±5% pounds per cubic yard;
a coarse aggregate in an amount of 1367±5% pounds per cubic yard;
water in an amount of 269±5% pounds per cubic yard; and
an air entraining agent in an amount of about 1.4±5% fluid ounces per cwt of hydraulic cement.

17. A concrete composition as in claim 16, the concrete composition having a 28-day compressive strength of at least about 4000 psi and a slump of at least about 5 inches as measured using a 12 inch slump cone according to ASTM C143.

18. A concrete composition as in claim 16, wherein:
the hydraulic cement is included in an amount of 366±3% pounds per cubic yard;
the pozzolanic material is included in an amount of 110±3% pounds per cubic yard;
the fine aggregate is included in an amount of 1654±3% pounds per cubic yard;
the coarse aggregate is included in an amount of 1367±3% pounds per cubic yard;
the water is included in an amount of 269±3% pounds per cubic yard; and
the air entraining agent is included in an amount of 1.4±3% fluid ounces per cwt of hydraulic cement.

19. A concrete composition as in claim 16, wherein:
the hydraulic cement is included in an amount of 366±2% pounds per cubic yard;
the pozzolanic material is included in an amount of 110±2% pounds per cubic yard;
the fine aggregate is included in an amount of 1654±2% pounds per cubic yard;
the coarse aggregate is included in an amount of 1367±2% pounds per cubic yard;
the water is included in an amount of 269±2% pounds per cubic yard; and
the air entraining agent is included in an amount of 1.4±2% fluid ounces per cwt of hydraulic cement.

20. A concrete composition as in claim 16, wherein:
the hydraulic cement is included in an amount of 366±1% pounds per cubic yard;
the pozzolanic material is included in an amount of 110±1% pounds per cubic yard;
the fine aggregate is included in an amount of 1654±1% pounds per cubic yard;
the coarse aggregate is included in an amount of 1367±1% pounds per cubic yard;
the water is included in an amount of 269±1% pounds per cubic yard; and
the air entraining agent is included in an amount of 1.4±1% fluid ounces per cwt of hydraulic cement.

21. A concrete composition as in claim 16, the concrete composition comprising about 5.5% by volume entrained air.

22. A concrete composition as in claim 16, the hydraulic cement consisting essentially of Type I and/or Type II Portland cement.

23. A concrete composition as in claim 16, the pozzolanic material consisting essentially of Type C fly ash.

24. A concrete composition as in claim 16, the fine aggregate consisting essentially of sand and the coarse aggregate consisting essentially of rock.

25. A concrete composition as in claim 21, the sand consisting essentially of FA-2 sand and the rock consisting essentially of CA-11 state rock, 34 inch.

26. A concrete composition as in claim 16, further comprising an amount of plasticizer that increases slump and decreases viscosity without causing significant segregation or bleeding of the concrete composition.

27. A concrete composition as in claim 16, further comprising one or more admixtures selected from the group consisting of air entraining agents, strength enhancing amines, dispersants, viscosity modifiers, set accelerators, set retarders, corrosion inhibitors, pigments, wetting agents, water soluble polymers, rheology modifying agents, water repellents, fibers, permeability reducers, pumping aids, fungicidal admixtures, germicidal admixtures, insecticidal admixtures, finely divided mineral admixtures, alkali reactivity reducer, and bonding admixtures.

28. A concrete composition having high workability and a high strength to cement ratio, comprising:
Type I and/or Type II Portland cement in an amount of 366±5% pounds per cubic yard;
Type C fly ash in an amount of 110±5% pounds per cubic yard;
sand in an amount of 1654±5% pounds per cubic yard;
rock in an amount of 1367±5% pounds per cubic yard;
water in an amount of 269±5% pounds per cubic yard; and
an air entraining agent in an amount of 1.4±5% fluid ounces per cwt of hydraulic cement,
the concrete composition having a 28-day design compressive strength of 4000 psi and a slump of at least about 5 inches as measured using a 12 inch slump cone according to ASTM C143.

29. A concrete composition having high workability and a high strength to cement ratio, comprising:
Type I and/or Type II Portland cement in an amount of 366±3% pounds per cubic yard;
Type C fly ash in an amount of 110 pounds±3% per cubic yard;
sand in an amount of 1654 pounds±3% per cubic yard;
rock in an amount of 1367 pounds±3% per cubic yard;
water in an amount of 269 pounds±3% per cubic yard; and
an air entraining agent in an amount of 1.4±3% fluid ounces per cwt of hydraulic cement,
the concrete composition having a 28-day design compressive strength of 4000 psi and a slump of at least about 5 inches as measured using a 12 inch slump cone according to ASTM C143.

30. A concrete composition having high workability and a high strength to cement ratio, comprising:
Type I and/or Type II Portland cement in an amount of 366±1% pounds per cubic yard;
Type C fly ash in an amount of 110 pounds±1% per cubic yard;
sand in an amount of 1654 pounds±1% per cubic yard;
rock in an amount of 1367 pounds±1% per cubic yard;
water in an amount of 269 pounds±1% per cubic yard; and
an air entraining agent in an amount of 1.4±1% fluid ounces per cwt of hydraulic cement,
the concrete composition having a 28-day design compressive strength of 4000 psi and a slump of at least about 5 inches as measured using a 12 inch slump cone according to ASTM C143.
